(19) United States
(12) Patent Application Publication
(10) Pub. No.: US 2005/0140500 A1
(43) Pub. Date: Jun. 30, 2005

(54) System and method for providing regional information using radio paging network

(75) Inventors: Byung-Wook Kim, Seoul (KR); Jin-Won Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/933,160

(22) Filed: Sep. 2, 2004

(30) Foreign Application Priority Data
Dec. 24, 2003 (KR) 96281/2003

(51) Int. Cl. H04Q 7/00

(52) U.S. Cl. 340/7.48; 455/414.2

(57) ABSTRACT

Disclosed is a system and a method for providing regional information using a radio paging network. The method includes the steps of: classifying an area into unit regions for providing regional information, assigning radio paging numbers different from each other according to the unit regions, and then constructing a radio paging number management database for managing the radio paging numbers according to the unit regions; storing the database in a regional information providing system and a plurality of information receiving apparatuses; detecting the respective radio paging numbers corresponding to each position of the information receiving apparatuses from the database; storing the detected radio paging numbers in respective corresponding information receiving apparatuses; when regional information of a predetermined region is generated, detecting a radio paging number the predetermined region corresponding to the regional information from the database; transmitting a radio paging message to the information receiving apparatuses through a radio paging network, the radio paging message including the radio paging number and the corresponding regional information; the information receiving apparatuses receiving only a radio paging message including the same radio paging number as that stored in advance; and the information receiving apparatuses outputting the regional information included in the received radio paging message.

### PRIORITY

This application claims priority to an application entitled “System And Method For Providing Regional Information Using Radio Paging Network” filed in the Korean Industrial Property Office on Dec. 24, 2003 and assigned Serial No. 2003-96281, the contents of which are hereby incorporated by reference.

### BACKGROUND OF THE INVENTION

1. Field of the Invention

The present invention relates to a system and a method for providing regional information, and more particularly to a system and a method for providing regional information, such as real-time traffic information, which is transmitted and received by means of a radio paging network, which is also called a pager network.

2. Description of the Related Art

Recently, information providing services using various communication networks have been developed and implemented. Particularly, a real-time traffic information providing service using a mobile radio communication network or the like has been implemented, and such real-time traffic information has provided very useful information for drivers affected by the increase of traffic volume. For example, traffic information regarding routes, on each of which a car is traveling or willtravel, is provided to each driver in real time, which enables the driver to avoid a road where there is more traffic.

At present, in order to provide such real-time traffic information, a method (for example, the “NATE” service provided by SK Telecom Company in the Republic of Korea) of communicating with a separate information server which is constructed to manage traffic information in real time, a method (for example, FM traffic broadcasting) using a broadcasting service, and a method using a data radio channel (DARC) have been used. Herein, the DARC method provides data corrected by a differential global positioning system, through FM (Frequency Modulation) broadcasting.

From among these methods, according to the method using a separate information server, a user is connected to a communication network and communicates with the information server, thereby being able to access real-time traffic information. In general, such information servers provide real-time traffic information with a fee. Accordingly, when using the method using a separate information server, a user must pay not only a communication charge to the communication network but also an information charge according to a period of time used for real-time traffic information.

The real-time traffic information providing method using a broadcasting service cannot be applied to route searching. Further, the real-time traffic information providing method using the DARC provides information having a poor accuracy, since it is impossible for a user to selectively obtain information of only a desired region by this method.

Therefore, it is necessary to develop a system and a method for providing real-time traffic information of corresponding routes according to movement of a user while minimizing the user's cost burden.

### SUMMARY OF THE INVENTION

Accordingly, the present invention has been made to solve the above-mentioned problems occurring in the prior art, and a first object of the present invention is to provide a system and a method for providing regional information to a user who is located in a predetermined region.

A second object of the present invention is to provide a system and a method for providing reliable real-time traffic information of a corresponding route according to movement of a moving object while minimizing a user's cost burden.

A third object of the present invention is to provide a system and a method for providing regional information of a route corresponding to movement of a user by means of a radio paging network.

A fourth object of the present invention is to provide a system and a method for providing real-time regional information, in which when regional information providing servers broadcast regional information corresponding to predetermined regions, a receiving terminal built in a moving object selects and receives regional information corresponding to its own position.

A fifth object of the present invention is to provide a system and a method for providing a regional information providing system which transmits regional information by means of a radio paging network.

A sixth object of the present invention is to provide a system and a method for providing an information receiving apparatus which receives information from a radio paging network.

To accomplish these objects, in accordance with one aspect of the present invention, there is provided a system for providing regional information, the system comprising: a radio paging number storage section for storing and managing radio paging numbers assigned according to predetermined unit regions; a radio paging number detecting section, when regional information of a predetermined region is generated, for detecting a radio paging number of a unit region including a link corresponding to the regional information from the radio paging number storage section; and an information transmitting section for transmitting the regional information and the radio paging number to a radio paging network.

In accordance with another aspect of the present invention, there is provided an apparatus for receiving regional information of a predetermined region from a regional information providing system, the information receiving apparatus comprising: a radio paging number management section for storing and managing radio paging numbers according to unit regions, the radio paging numbers being equal to those of the regional information providing system; a position detecting section for detecting a position of the information receiving apparatus and for outputting a link number corresponding to the detected position; a radio paging number detecting section for detecting a radio paging number corresponding to the position from the radio paging number management section on the basis of the link number inputted from the position detecting section; a radio paging number storage section for changing a radio paging number of the information receiving apparatus to the radio paging number detected in the radio paging number detecting section and for storing the changed radio paging number; a radio paging message receiving section for receiving only radio paging messages including the same radio paging number as that stored in the radio paging number storage section, from among radio paging messages which includes regional information and which have been broadcasted from a radio paging network; and a regional information output section for outputting the regional information included in the radio paging message which is received in the radio paging message receiving section.

In accordance with still another aspect of the present invention, there is provided a method of providing regional information, the method comprising the steps of: classifying an area into unit regions for providing regional information, assigning radio paging numbers corresponding to the unit regions, and then constructing a radio paging number management database for managing the radio paging numbers according to the unit regions; storing the database in a regional information providing system and a plurality of information receiving apparatuses; detecting the respective radio paging numbers corresponding to each position of the information receiving apparatuses from the database; storing the detected radio paging numbers in respective corresponding information receiving apparatuses; when regional information of a predetermined region is generated, the regional information providing system detecting a radio paging number of the predetermined region corresponding to the regional information from the database; the regional information providing system transmitting a radio paging message to the information receiving apparatuses through a radio paging network, the radio paging message including the radio paging number and the corresponding regional information; the information receiving apparatuses receiving only a radio paging message including the same radio paging number as that stored in the corresponding information receiving apparatus; and the information receiving apparatuses outputting the regional information included in the received radio paging message.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a general radio paging network;

FIG. 2 is a view showing a format of a general radio paging message;

FIG. 3 is a block diagram of a traffic information providing system according to an embodiment of the present invention;

FIGS. 4A and 4B are views of a general method of storing map data;

FIGS. 5A and 5B are views explaining regions to which the traffic information is provided according to an embodiment of the present invention;

FIGS. 6A and 6B are views illustrating database configurations for managing radio paging numbers according to an embodiment of the present invention;

FIG. 7 is a block diagram illustrating a traffic information receiving terminal according to an embodiment of the present invention; and

FIG. 8 is a flowchart of a method of providing traffic information according to an embodiment of the present invention.

### DETAILED DESCRIPTION OF THE PREFERRED EMBODIMENT

Hereinafter, a preferred embodiment of a system and a method for providing regional information using a radio paging network according to the present invention will be described with reference to the accompanying drawings. In the following description of the present invention, a detailed description of known functions and configurations incorporated herein will be omitted when it may make the subject matter of the present invention unclear.

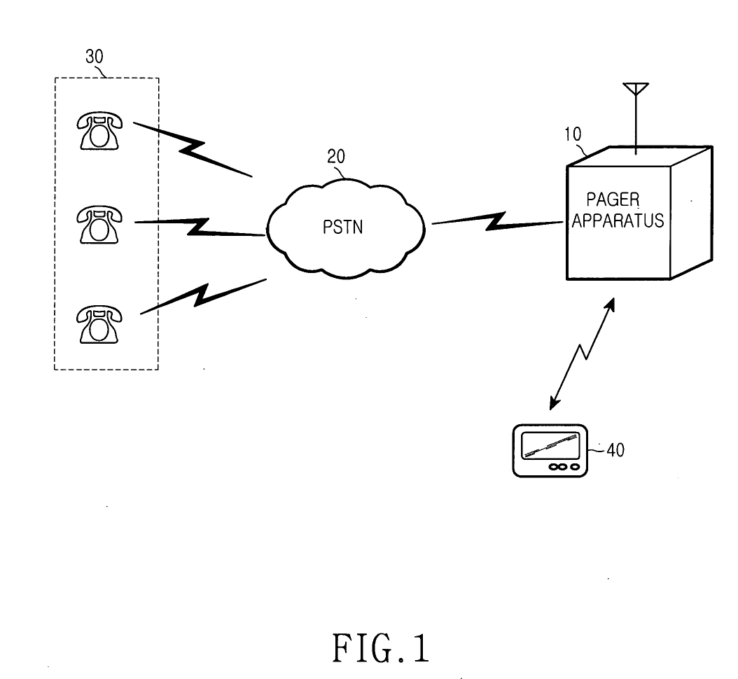

FIG. 1 is a block diagram for conceptually showing a general radio paging network. Referring to FIG. 1, a general radio paging network includes a pager apparatus 10, which is also called a radio paging terminal, and a receiving terminal 40. The pager apparatus 10 is connected to a public switched telephone network (hereinafter, referred to as ‘PSTN’) 20 and processes radio paging requests of a plurality of wire telephones 30, and the receiving terminal 40 receives a radio paging signal transmitted from the pager apparatus 10. In general, since such a radio paging network performs one-way communication, the system configuration thereof is quite simple.

In general, when calling a person having the receiving terminal 40 in the above-mentioned radio paging network, a caller dials a radio paging number assigned to the receiving terminal 40 by means of a wire telephone 30 and inputs a caller identification number, such as a telephone number or the like. Then, the radio paging number and the caller identification number are transmitted to the pager apparatus 10 through the PSTN 20. The PSTN 20 generates a radio paging message using the radio paging number and the caller identification number, and then broadcasts the radio paging message wirelessly to terminal 40. Meanwhile, the receiving terminal 40 wirelessly confirms radio paging messages broadcasted within a predetermined period, and then receives a radio paging message having been transmitted to the receiving terminal 40. That is, when confirming that the radio paging number included in the radio paging message is identical to one assigned to the receiving terminal 40, the receiving terminal 40 receives the radio paging message, and displays information of the caller on a screen of the receiving terminal while notifying its user that the receiving terminal 40 is receiving a call. For example, the receiving terminal 40 either outputs a bell sound or drives a vibration motor.

This invention is not limited to the pager apparatus 10 connected to the PSTN 20. That is, the pager apparatus 10 may connect to a mobile radio communication network to process call requests of mobile terminals. Furthermore, receiving terminal 40 may be a pager, or a mobile terminal such as a mobile telephone, PDA or the like, having a paging function.

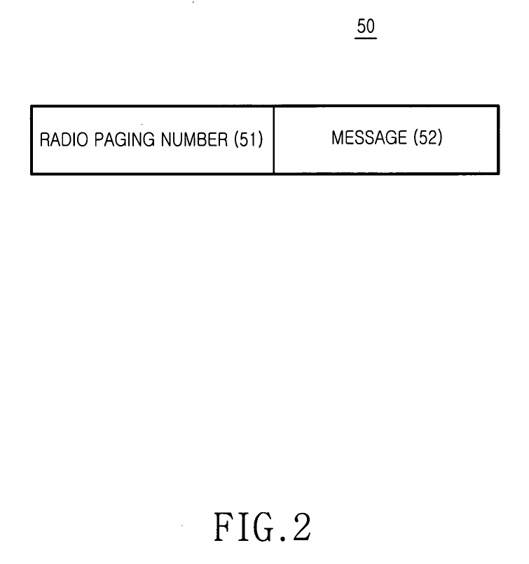

FIG. 2 shows a format of a general radio paging message. Referring to FIG. 2, a radio paging message 50 includes a radio paging number 51 and a message 52. The radio paging number 51 is a particular number for identifying a receiving terminal (indicated by a reference number 40 in FIG. 1) in a radio paging network and is a normal radio paging number. The message 52 is a message which a caller desires to transmit to a receiving terminal. In general, a telephone number of the caller inputted by the caller is stored in the region of the message 52.

Meanwhile, in such a radio paging network, messages are generally transmitted by a Post Office Code Standardization Advisory Group (POCSAG) method constructed on the basis of the Bose-Chaudhuri-Hocquenghem (BCH) theory. When a message is transmitted by the POCSAG method, it is possible to call fifteen times a second.

Therefore, in a case in which a receiving terminal for the radio paging network is contained in a moving object, such as on a person or in a vehicle, and the pager apparatus transmits regional information, such as traffic information according to regions and the like, by a method for transmitting a radio paging message, a user can use real-time regional information with no communication expense requested to connect to a server. This embodiment refers to a system and a method for providing the real-time regional information by using such a radio paging network.

Hereinafter, the following description will be based on an example using traffic information.

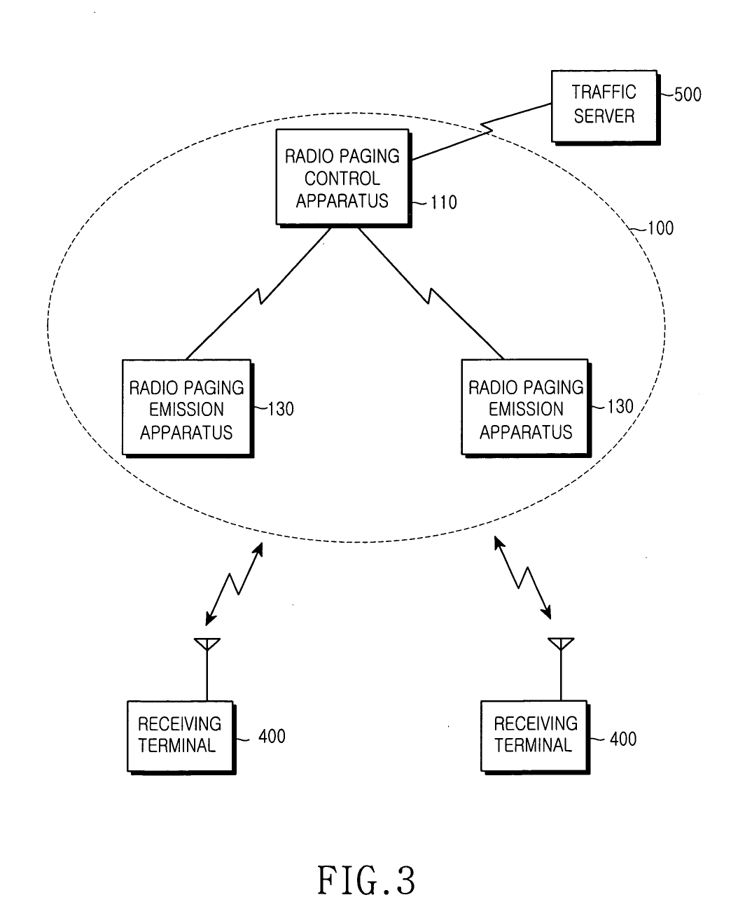

FIG. 3 is a block diagram of a traffic information providing system according to an embodiment of the present invention, and particularly a block diagram of a system which provides traffic information according to regions. The regional information providing system includes a traffic server 500 for generating real-time traffic information and wirelessly transmitting the generated real-time traffic information through a radio paging network 100, and receiving terminals 400 for receiving and outputting the real-time traffic information transmitted from the radio paging network 100. The radio paging network 100 includes a radio paging control apparatus 110 and radio paging emission apparatuses 130. The radio paging control apparatus 110 is connected with the traffic server, receives the real-time traffic information, and generates a radio paging message including the real-time traffic information. The radio paging emission apparatus 130 sends the radio paging message to a predetermined region.

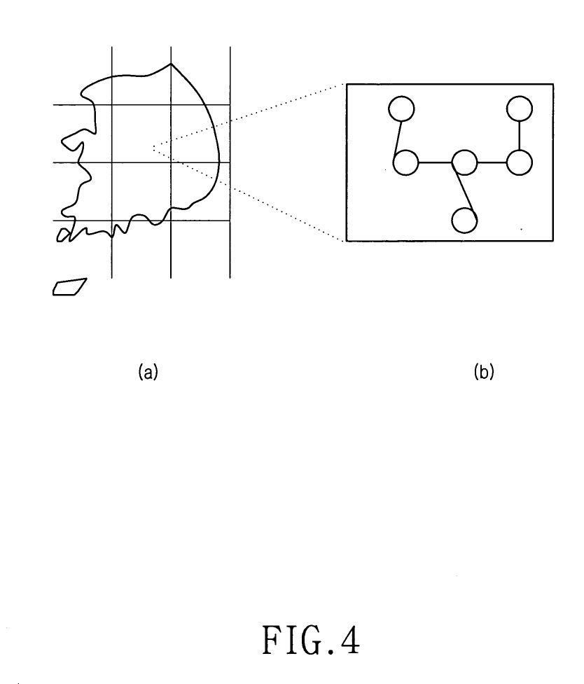

The traffic server 500 classifies an area into a plurality of unit regions to be provided with the real-time traffic information, assigns the respective unit regions radio paging numbers different from each other, and then constructs and stores a radio paging number management database for managing the radio paging numbers according to the unit regions. In this case, it is preferred that the unit regions are divided based on links of map data. For example, the traffic server 500 constructs and stores either a radio paging number management database for assigning and managing different radio paging numbers according to links which constitutes the map data, or a radio paging number management database for assigning and managing different radio paging numbers according to regions established in such a manner that each of the regions includes a predetermined number of adjacent links. A method of classifying an area into a plurality of unit regions, assigning radio paging numbers to the unit regions, and managing the assigned radio paging numbers will be described in more detail with reference to FIGS. 4A to 6B.

Also, when real-time traffic information is generated due to changes in traffic information, etc., of a predetermined region, the traffic server 500 detects a radio paging number corresponding to a region, in which the real-time traffic information is generated, from the radio paging number management database, and then the traffic server 500 transmits the real-time traffic information and the radio paging number corresponding to the region in which the real-time traffic information is generated to the radio paging control apparatus 110.

In order to perform such a function, it is preferred that the traffic server 500 includes a radio paging number storage section (not shown), a radio paging number detecting section (not shown), and a traffic information transmitting section (not shown). The radio paging number storage section stores the radio paging number management database. When real-time traffic information of a predetermined region is generated, the radio paging number detecting section detects a radio paging number of a unit region including a link corresponding to the real-time traffic information from the radio paging number storage section. The traffic information transmitting section transmits the real-time traffic information and the radio paging number to the radio paging network 100.

Then, the radio paging control apparatus 110 generates a radio paging message by using the real-time traffic information and the radio paging number of a corresponding region, and transmits the radio paging message to the radio paging emission apparatus 130.

The radio paging emission apparatus 130 emits the radio paging message, which is transmitted from the radio paging control apparatus 110 and includes the real-time traffic information, to a receiving terminal 400. In this case, the radio paging emission apparatus 130 emits the radio paging message by a broadcasting method.

The receiving terminal 400 may be contained in a moving object such as a vehicle and includes the radio paging number management database stored in the radio paging control apparatus 110. The receiving terminal 400 detects a radio paging number corresponding to a changed position of the moving object from the radio paging number management database, and changes the radio paging number of the receiving terminal 400. Also, the receiving terminal 400 selectively receives only radio paging messages, which include the same radio paging number as that of the receiving terminal 400 itself, from among radio paging messages emitted from the radio paging emission apparatus 130, and outputs traffic information included in the received radio paging messages. In this case, it is preferred that the receiving terminal 400 includes at least one of a speaker and a display, so as to output the traffic information by at least one of a visible method and an audible method.

FIGS. 4A and 4B are views of a general method of storing map data. Typically, for rapid search in map data, a total map is classified into a plurality of parts (known as “map sections”) of a predetermined unit size, and road information is displayed by means of nodes and links in each of the map sections. FIG. 4A is a view showing a map of South Korea, which is classified into 12 map sections, and FIG. 4B is a view showing one of the 12 map sections, in which road information is displayed with nodes and links. In this embodiment, either each of the links or each of regions constructed by gathering a predetermined number of adjacent links is established as a unit region, and different radio paging numbers are assigned according to the corresponding unit regions.

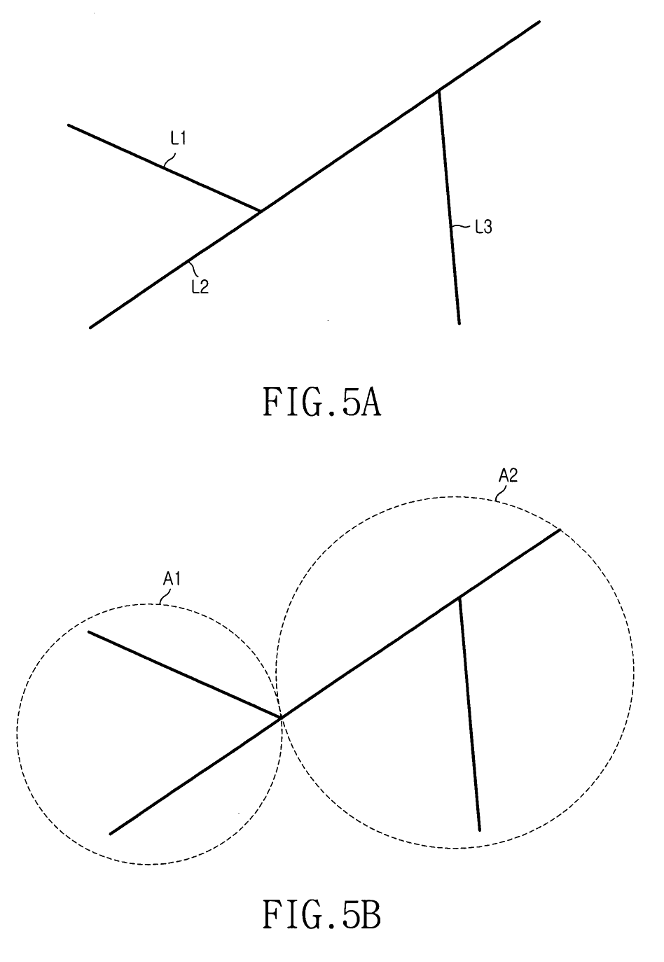

FIGS. 5A and 5B are views for illustratively explaining regions to which the traffic information is provided according to an embodiment of the present invention. That is, FIG. 5A illustrates a first example in which each of the links L1 to L3 constructing map data, as illustrated in FIG. 4, is established as a unit region to be provided with traffic information, and FIG. 5B illustrates a second example in which each of regions A1 and A2 constructed by gathering a predetermined number of adjacent links is established as a unit region to be provided with traffic information. In this case where each of the regions constructed by gathering a predetermined number of adjacent links is established as a unit region to be provided with traffic information, it is preferred that the database for managing unit-region information further includes a field for managing information of links which is included in the respective relevant regions.

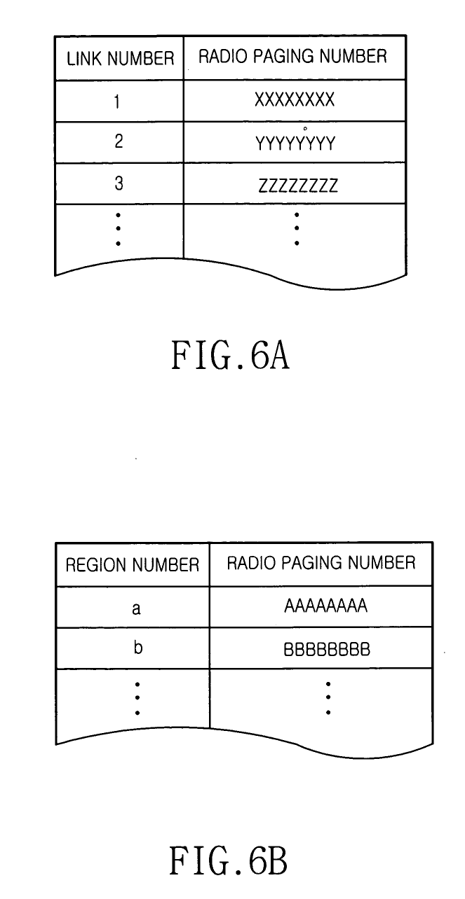

FIGS. 6A and 6B are views illustrating database configurations for managing radio paging numbers according to an embodiment of the present invention. The database, shown in FIGS. 6A and 6B, is constructed so as to manage radio paging numbers according to the unit regions to which the traffic server 500 provides real-time traffic information, and is shared with the receiving terminal 400.

FIG. 6A shows an example of a data configuration corresponding to unit regions shown in FIG. 5A, and FIG. 6B shows an example of a data configuration corresponding to unit regions shown in FIG. 5B. Referring to FIG. 6A, it is understood that different radio paging numbers are assigned with respect to each other according to the links. Also, referring to FIG. 6B, it is understood that different radio paging numbers are assigned with respect to each other according to the regions, each of which is regarded as an identical region in FIG. 5B.

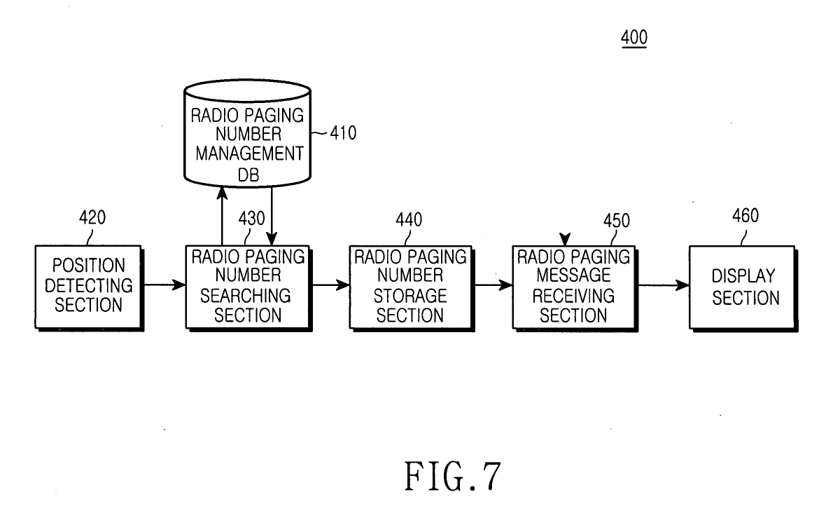

FIG. 7 is a block diagram for illustrating a traffic information receiving terminal 400 according to an embodiment of the present invention. Referring to FIG. 7, the receiving terminal 400 includes a radio paging number management database 410, a position detecting section 420, a radio paging number searching section 430, a radio paging number storage section 440, a radio paging message receiving section 450, and a display section 460.

The radio paging number management database 410 manages the radio paging numbers which are assigned to the respective unit regions having different values from each other according to the unit regions. The radio paging number management database 410 is the same as a radio paging number management database managed in the traffic server 500, and its configuration is the same as those exampled in FIGS. 6A and 6B. This construction enables the receiving terminal 400 to properly receive real-time traffic information according to the unit regions transmitted from the traffic server 500.

The position detecting section 420 detects a position of a moving object in which the receiving terminal 400 is contained, and outputs a link number (ID) corresponding to the position of the moving object according to the result. Various well-known methods may be applied as a method for detecting a position of a moving object in the position detecting section 420. For example, the position detecting section 420 may include a GPS receiver and detect a position of a moving object by using a GPS signal received through the GPS receiver. Meanwhile, since a position of a moving object is the same as that of the receiving terminal 400, it may be said that the position detecting section 420 detects a position of the receiving terminal 400 and outputs a link number (ID) corresponding to the detected position.

The radio paging number searching section 430 searches the radio paging number management database 410 so as to find a radio paging number corresponding to the link number (ID) inputted from the position detecting section 420. If the radio paging number management database 410 manages radio paging numbers not according to the links but according to the regions each of which includes a predetermined number of adjacent links, the radio paging number searching section 430 searches the radio paging number management database 410 to first detect a regional information which includes the link number (ID) inputted from the position detecting section 420, and then detects a radio paging number corresponding to the detected region.

The radio paging number storage section 440 stores the radio paging number detected in the radio paging number searching section 430. Herein, the radio paging number stored in the radio paging number storage section 440 is a radio paging number assigned to a link on which the receiving terminal 400 is located. Therefore, all receiving terminals positioned in a same unit region, such as a same link or a same region, to be provided with real-time traffic information store a same radio paging number, so that the receiving terminals positioned in the same unit region can receive the same real-time traffic information.

In the meantime, the radio paging number stored in the radio paging number storage section 440 may change, and a new radio paging number is stored according to change of position of a moving object in which the receiving terminal 400 is contained. That is, when the position detecting section 420 senses the change of a position of the moving object and outputs a link number (ID) corresponding to the changed position, the radio paging number searching section 430 detects a radio paging number corresponding to the link number (ID) in the radio paging number management database 410 and transmits the detected radio paging number to the radio paging number storage section 440. Then, the radio paging number storage section 440, which has received the detected radio paging number, changes a radio paging number of a relevant receiving terminal for the newly detected radio paging number.

The radio paging message receiving section 450 receives only radio paging messages including the same radio paging number as that stored in the radio paging number storage section 440, from among radio paging messages broadcasted from the radio paging network.

The display section 460 extracts and displays real-time traffic information of a unit region, in which the receiving terminal 400 is located, from the received radio paging message. That is, the real-time traffic information is outputted in a form which a user can understand. In this case, it is preferred that the display section 460 includes at least one of a speaker and a display, so as to output the real-time traffic information by at least one of a visible method and an audible method.

Also, the radio paging number storage section 440 may additionally store another radio paging number corresponding to a specific region, such as a region that a user desires to obtain real-time traffic information thereof or a region corresponding to an ID of a route a user intends to travel, so as to provide selective information for the user. Such a construction enables the receiving terminal 400 to receive real-time traffic information of the specific region regardless of a position of the receiving terminal 400.

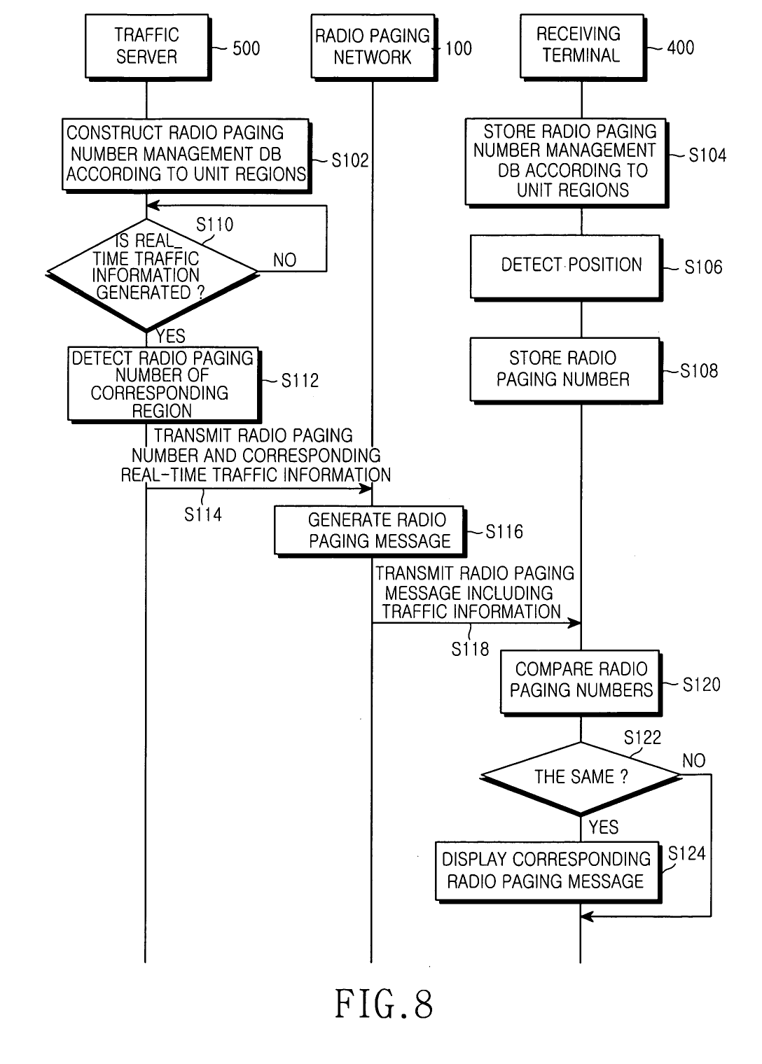

FIG. 8 is a flowchart of a method of providing traffic information according to an embodiment of the present invention. In FIG. 8, a traffic server 500, a radio paging network 100, and a receiving terminal 400 have the same construction as those of the traffic server 500, the radio paging network 100, and the receiving terminal 400 shown in FIGS. 3 to 7, respectively.

Referring to FIG. 8, the traffic server 500 classifies an area into unit regions to be provided with real-time traffic information, and assigns different radio paging numbers for each of the respective unit regions. Then, the traffic server 500 constructs and stores a radio paging number management database for managing the radio paging numbers according to the unit regions at step 102. In this case, it is preferred that the unit regions are classified according to links of map data.

The traffic server 500 shares its radio paging number management database with the receiving terminal 400. There are various methods for sharing the radio paging number management database with the receiving terminal 400. For example, the radio paging number management database may be either stored in the receiving terminal 400 when the receiving terminal 400 is manufactured, or transmitted from the traffic server 500 to the receiving terminal 400 through a communication network, so as to be stored in the receiving terminal 400.

Through one of the above-mentioned methods, the receiving terminal 400 receives and stores the radio paging number management database at step 104.

Then, the receiving terminal 400 detects a position of a moving object which contains the receiving terminal at step 106. At this time, if the position of the moving object changes, the receiving terminal 400 detects a radio paging number corresponding to the changed position, establishes the detected radio paging number as a radio paging number for the receiving terminal 400, and then stores the detected radio paging number in a radio paging number storage section of the receiving terminal 400 at step 108. That is, the receiving terminal 400 detects a radio paging number corresponding to the changed position of the moving object from among the radio paging numbers in the radio paging number management database stored in step 104, and establishes the detected radio paging number as a radio paging number for the receiving terminal 400. Steps 106 and 108 are repeated according to position change of the moving object.

When real-time traffic information is generated in a predetermined region managed by the traffic server 500 at step 110, the traffic server 500 searches the radio paging number management database constructed in step 102 and detects a radio paging number of a region corresponding to the real-time traffic information at step 112. Next, the traffic server 500 transmits the detected radio paging number and the corresponding real-time traffic information to the radio paging network 100 at step 114.

Then, the radio paging network 100 generates a radio paging message which has the radio paging number as a destination and has the corresponding real-time traffic information as the message contents at step 116, and transmits the radio paging message including the real-time traffic information to the receiving terminal 400 at step 118.

The receiving terminal 400, having received the radio paging message, compares the radio paging number included in the received radio paging message with the radio paging number stored in step 108 at step 120. As a result of the comparison, at step 122, if the radio paging number included in the radio paging message which is transmitted in step 118 is identical to the radio paging number established in step 108, the receiving terminal 400 receives the relevant radio paging message and displays the contents of the received radio paging message at step 124. In this case, it is preferred that a method of displaying the contents of the received radio paging message includes at least one of visible and audible methods.

Meanwhile, in step 108, it is preferred the receiving terminal 400 stores not only a radio paging number corresponding to a position change of a moving object in which the receiving terminal 400 is contained, but also another radio paging number corresponding to a specific region, such as a region that user desires to obtain real-time traffic information thereof or a region corresponding to an ID of a route a user wants to travel, selectively chosen by the user. Such a construction as described above enables the receiving terminal 400 to receive real-time traffic information of the specific region regardless of a position of the receiving terminal 400, so a user can refer to the real-time traffic information of the specific region when determining a traveling route. While one embodiment of a regional information providing system for providing traffic information using a radio paging network is described, the regional information providing system of the present invention is not limited to traffic information. For example, when the traffic server 500 shown in FIG. 3 is replaced by another information providing server, a system of the present invention can provide corresponding information.

According to the present invention as described above, since regional information is broadcasted using a radio paging network the construction of which is simple due to performing one-way communication, there is an advantage of a minimizing a user's cost burden for real-time regional information. Also, since the present invention utilizes a radio paging network which has already been constructed but is not much used, it has another advantage of increasing the utility of the radio paging network. In addition, in a system and a method according to the present invention, only the information on a region in which a user is located or which a user wants to get is provided in a broadcasting method. Therefore, the present invention can reduce the waste of resources due to transmission of unnecessary information.

While the invention has been shown and described with reference to certain preferred embodiments thereof, it will be understood by those skilled in the art that various changes in form and details may be made therein without departing from the spirit and scope of the invention as defined by the appended claims.

1. A system for providing regional information, the system comprising:
a radio paging number storage section for storing and managing radio paging numbers assigned according to predetermined unit regions;
a radio paging number detecting section, when regional information of a predetermined region is generated, for detecting a radio paging number of a unit region including a link corresponding to the regional information from the radio paging number storage section; and
an information transmitting section for transmitting the regional information and the radio paging number to the radio paging network.

2. The system for providing regional information as claimed in claim 1, wherein the radio paging number storage section stores the unit regions and the radio paging numbers and manages the radio paging numbers, each of the paging numbers corresponding to one of the unit regions, map data being classified into the unit regions based on links constituting the map data, each of the unit regions including a link.

3. The system for providing regional information as claimed in claim 2, wherein each of the unit regions includes a predetermined number of links adjacent to each other.

4. The system for providing regional information as claimed in claim 1, wherein the regional information is real-time traffic information.

5. The system for providing regional information as claimed in claim 2, wherein the regional information is real-time traffic information.

6. An apparatus for receiving regional information corresponding predetermined regions from a regional information providing system, the information receiving apparatus comprising:
a radio paging number management section for storing and managing radio paging numbers according to unit regions, the radio paging numbers being the same as those of the regional information providing system;
a position detecting section for detecting a position of the information receiving apparatus and for outputting a link number corresponding to the detected position;
a radio paging number detecting section for detecting a radio paging number corresponding to the position of the information receiving apparatus from the radio paging number management section on the basis of the link number inputted from the position detecting section;
a radio paging number storage section for changing a radio paging number of the information receiving apparatus to the radio paging number detected in the radio paging number detecting section and for storing the changed radio paging number;
a radio paging message receiving section for receiving only radio paging messages including the same radio paging number as that stored in the radio paging number storage section, from among radio paging messages which include regional information and have been broadcasted from a radio paging network; and
a regional information output section for outputting the regional information included in the radio paging message which is received in the radio paging message receiving section.

7. The apparatus as claimed in claim 6, wherein the information receiving apparatus is contained in a moving object.

8. The apparatus as claimed in claim 6, wherein the radio paging number storage section stores the unit regions and the radio paging numbers and manages the radio paging numbers, each of the paging numbers corresponding to one of the unit regions, map data being classified into the unit regions based on links constituting the map data, each of the unit regions including a link.

9. The apparatus as claimed in claim 8, wherein each of the unit regions includes a predetermined number of links adjacent to each other.

10. The apparatus as claimed in claim 6, wherein the radio paging number storage section changes a radio paging number of the information receiving apparatus to a radio paging number corresponding to a specific region selected according to selection information provided by a user, and stores the changed radio paging number.

11. The apparatus as claimed in claim 6, wherein, the regional information is real-time traffic information.

12. The apparatus as claimed in claim 8, wherein the regional information is real-time traffic information.

13. The apparatus as claimed in claim 10, wherein the regional information is real-time traffic information.

14. A method of providing regional information, the method comprising the steps of:
(a) classifying an area into unit regions for providing regional information, assigning radio paging numbers corresponding to each of the unit regions, and then constructing a radio paging number management database for managing the radio paging numbers according to the unit regions;
(b) storing the database in a regional information providing system and a plurality of information receiving apparatuses;
(c) detecting the respective radio paging numbers corresponding to each position of the information receiving apparatuses from the database;
(d) storing the detected radio paging numbers in respective corresponding information receiving apparatuses;
(e) detecting by the regional information providing system a radio paging number of the predetermined region corresponding to the regional information from the database, when regional information of a predetermined region is generated;
(f) transmitting by the regional information providing system a radio paging message to the information receiving apparatuses through a radio paging network, the radio paging message including the radio paging number and the corresponding regional information;
(g) receiving in the information receiving apparatuses only a radio paging message including the same radio paging number as that stored in step
(d); and
(h) outputting by the information receiving apparatuses the regional information included in the radio paging message received in step (g).

15. The method as claimed in claim 14, wherein, in step (a), unit regions are classified by links constituting map data and different radio paging numbers are assigned according to the links.

16. The method as claimed in claim 14, wherein, in step (d), a radio paging number corresponding to a specific region selected according to selection information provided by a user is additionally stored.

17. The method as claimed in claim 14, wherein the regional information is real-time traffic information.

18. The method as claimed in claim 15, wherein the regional information is real-time traffic information.

19. The method as claimed in claim 16, wherein the regional information is real-time traffic information.
